(19) United States
(12) Patent Application Publication
(10) Pub. No.: US 2006/0187187 A1
(43) Pub. Date: Aug. 24, 2006

(54) Display device

(75) Inventors: Mark Thomas Johnson, Eindhoven (NL); Guofu Zhou, Eindhoven (NL); Neculai Ailenei, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/562,544

(22) PCT Filed: Jun. 30, 2004
(86) PCT No.: PCT/IB04/51052

§ 371 Date: Dec. 28, 2005

(30) Foreign Application Priority Data
Jul. 3, 2003 (EP) 03101992.0

(51) Int. Cl. G09G 3/34

(52) U.S. Cl. 345/107

(57) ABSTRACT

A display device comprising electrophoretic particles, a display element comprising a pixel electrode and a counter electrode between which a portion of the electrophoretic particles are present, and control means for supplying a drive signal to the electrodes to bring the display element in a predetermined optical state corresponding to the image information to be displayed, characterized in that control means are further arranged for supplying a preset signal preceding the drive signal comprising a preset pulse having an energy sufficient to release the electrophoretic particles at a first position near one of the two electrodes corresponding to a first optical state, but too low to enable the particles to reach a second position near the other electrode corresponding to a second optical state, and in that the control means are further arranged for supplying the preset signal, in anticipation of or upon receipt of a power-up or image change operation.

The invention relates to a display device comprising electrophoretic particles, a display element comprising a pixel electrode and a counter electrode between which a portion of the electrophoretic particles are present, and control means for supplying a drive signal to the electrodes to bring the display element in a predetermined optical state.

Display devices of this type are used in, for example, monitors, laptop computers, personal digital assistants (PDA's), mobile telephones, electronic books electronic newspapers, and electronic magazines.

A display device of the type mentioned in the opening paragraph is known from the international patent application WO 99/53373. This patent application discloses a electronic ink display comprising two substrates, one of which is transparent, the other substrate is provided with electrodes arranged in row and columns. A crossing between a row and a column electrode is associated with a display element. The display element is coupled to the column electrode via a thin film transistor (TFT), the gate of which is coupled to the row electrode. This arrangements of display elements, TFT transistors and row and column electrode together forms an active matrix. Furthermore, the display element comprises a pixel electrode. A row driver selects a row of display elements and the column driver supply a data signal to the selected row of display elements via the column electrodes and the TFT transistors. The data signals corresponds to graphic data to be displayed.

Furthermore, an electronic ink is provided between the pixel electrode and a common electrode provided on the transparent substrate. The electronic ink comprises multiple microcapsules, of about 10 to 50 microns. Each microcapsule comprises positively charged white particles and negatively charge black particles suspended in a fluid. When a positive field is applied to the pixel electrode, the white particles move to the side of the micro capsule directed to the transparent substrate and the display element becomes visible to a viewer. Simultaneously, the black particles move to the pixel electrode at the opposite side of the microcapsule where they are hidden to the viewer. By applying a negative field to the pixel electrode, the black particles move to the common electrode at the side of the micro capsule directed to the transparent substrate and the display element appears dark to a viewer. When the electric field is removed the display device remains in the acquired state and exhibit a bi-stable character.

Grey scales can be created in the display device by controlling the amount of particles that move to counter electrode at the top of the microcapsules. For example, the energy of the positive or negative electric field, defines as the product of field strength and time of application, controls the amount of particles moving to the top of the microcapsules.

The known display devices exhibit a so called dwell time. The dwell time is defined as the interval between a previous image update and a new image update.

A disadvantage of the present display is that it exhibits an underdrive effect which leads to inaccurate grey scale reproduction. This underdrive effect occurs, for example, when an initial state of the display device is black and the display is periodically switched between the white and black state. For example, after a dwell time of several seconds, the display device is switched to white by applying a negative field for an interval of 200 ms. In a next subsequent interval no electric field is applied for 200 ms and the display remains white and in a next subsequent interval a positive field is applied for 200 ms and the display is switched to black. The brightness of the display as a response of the first pulse of the series is below the desired maximum brightness, which can be reproduced several pulses later. This underdrive effect can be reduced by using a preset signal.

Another point of consideration is energy and energy conservation. A great advantage of the type of displays as described in the opening paragraph is that once an image is formed the image remains even after the power is shut off. For this reason the necessary power consumption is low, and the display will spend the majority of its life turned off (i.e. in a “standby mode”). In most cases, an image update sequence (i.e. a new image to be displayed) will require that the system is powered up immediately before image update. In general, we will have to wait until the system is fully powered up before we can start the image update. This will therefore slow down the image update. The advantage of the display device (low energy consumption) then becomes a disadvantage (relatively slow start-up).

It is an object of the invention to provide a display device of the type mentioned in the opening paragraph which can be applied to improve the reproduction of grey scales.

To achieve this object, a first aspect of the invention provides a display device as described in the opening paragraph characterized in that the control means are further arranged for supplying a preset signal preceding the drive signal comprising a preset pulse preceding a drive pulse, the preset pulse having an energy sufficient to release the electrophoretic particles at a first position near one of the two electrodes corresponding to a first optical state, but too low to enable the particles to reach a second position near the other electrode corresponding to a second optical state and in that the control means are further arranged for supplying the preset signal, in anticipation of or upon receipt of a power-up or image change operation.

The invention is based on the recognition that the optical response depends on the history of the display element. The inventors have observed that when a preset signal is supplied before the drive signal to the pixel electrode, which preset signal comprising a pulse with an energy sufficient to release the electrophoretic particle from a static state at one of the two electrodes, but too low too reach the other one of the electrodes, the underdrive effect is reduced. Because of the reduced underdrive effect the optical response to an identical data signal will be substantially equal, regardless of the history of the display device and in particular its dwell time. The underlying mechanism can be explained because after the display device is switched to a predetermined state e.g. a black state, the electrophoretic particles become in a static state, when a subsequent switching is to the white state, a momentum of the particles is low because their starting speed is close to zero. This results in a long switching time. The application of the preset pulses increases the momentum of the electrophoretic particles and thus shortens the switching time.

A further advantage is that the application of the preset pulses substantially eliminates a prior history of the electronic ink, whereas in contrast conventional electronic ink display devices requires massive signal processing circuits for the generation of data pulses of a new frame, storage of several previous frames and a large look-up table.

The application of the preset pulses may, however, lengthen the start-up cycle period, since the preset pulses (or shake pulses as the will also be called below) take time.

However, the inventors have realized that shaking (i.e. application of preset pulses), whilst highly beneficial for a high quality image update, can be data independent (shaking does not have to depend upon the details of the image to be displayed), is optically hardly visible or invisible to the user and, as the optical state before and after shaking is substantially unchanged, can be implemented at any time (also the WRONG time) without deteriorating the performance of the display.

For this reason, shaking pulses can be applied to the display even if there is no certainty that an image update will follow the shaking. If, as will usually happen, an image update does follow a power-up (or mode change) we can save image update time (as the shaking has already been carried out). In that case the preset pulses are applied prior to completion of receipt of image update data.

If, in the less likely case that no image update follows a power-up (or mode change), we have in any case done no harm to the image on the display.

Thus the preset pulses in the device in accordance with the application are applied even before the receipt of the “new” image data is completed. The start-up period is thereby shortened.

The start-up period can be further shortened, for devices having a touch button, by control means which are arranged to initiate preset pulses starting at a touch time shorter than the touch time for initiating an update of the image data.

In many situations, the request for an image update will be originated by a touch input (i.e pressing a hardware or software button). Touch input events usually require a period of several 100 msec, as the touch pressure has to be built up to exceed a predefined value for a certain period of time (to make sure that the button has really been touched!). In a preferred embodiment the onset of the preset pulses is triggered at a touch time shorter than shorter than the touch time for initiating an update of the image data, at which point we propose to start up an initialisation with shaking sequence. This reduced touch event will be detected more quickly. The onset of the application of the preset pulse(s) is thus done in anticipation of a power-up or image change operation (i.e. a full touch event). If a full touch event is subsequently detected, the sequence will begin more quickly, whereby the image update will again be shorter. In the case of a false touch event (reduced touch detected, full touch not detected), no adverse effects will be seen in the display, as the shaking leaves the display in the same state as before shaking occurs.

Further advantageous embodiments of the invention are specified in the dependent claims.

In an embodiment a preset signal consisting of an even number of preset pulses of opposite polarity can be generated for minimising the DC component and the visibility of the preset pulses of the display device. Two preset pulses, one with positive polarity and one with negative polarity will minimize the power dissipation of the display device within this mode of operation.

In an embodiment the electrodes are arranged to form a passive matrix display.

In an embodiment the display device is provided with an active matrix addressing to provide the data signals to the pixel electrodes of the display elements.

These and other aspects of the invention are apparent from and will be elucidated with reference to the embodiments described hereinafter.

In the drawings:

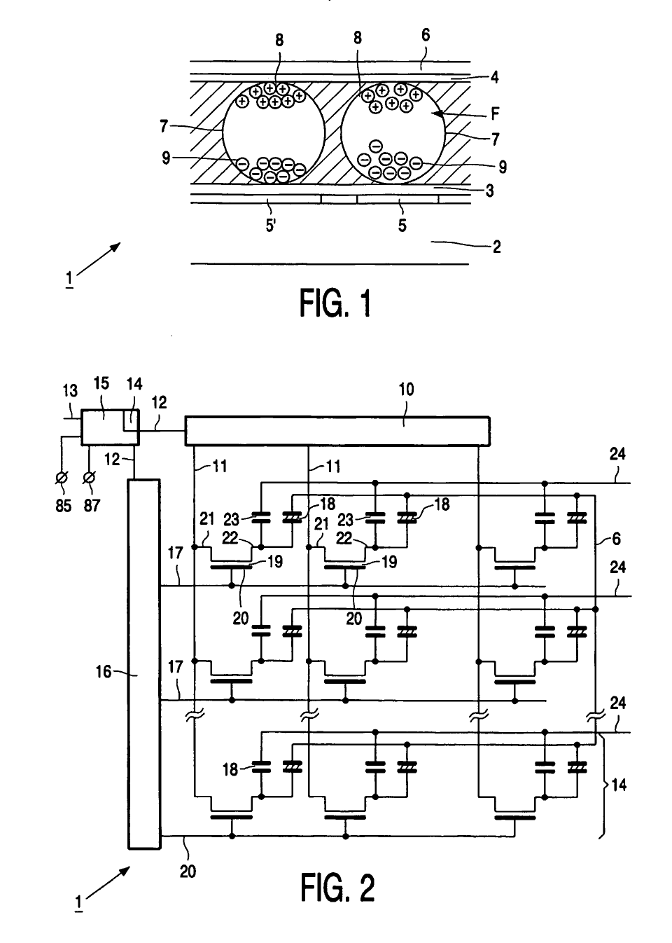

FIG. 1 shows diagrammatically cross-section of a portion of a display device,

FIG. 2 shows diagrammatically an equivalent circuit diagram of a portion of a display device,

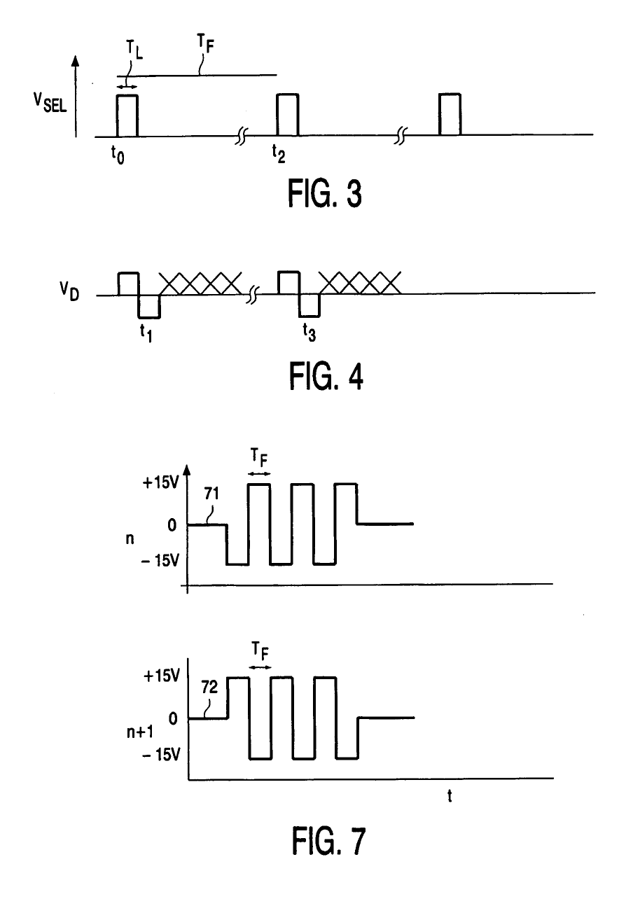

FIGS. 3 and 4 shows drive signals and internal signal of the display device,

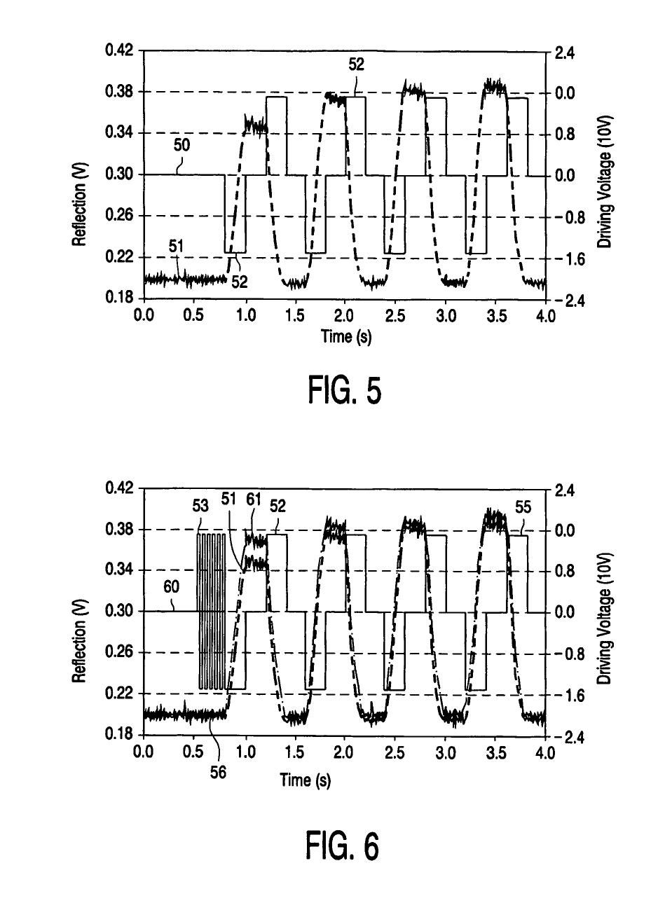

FIG. 5 shows an optical response of a data signal,

FIG. 6 shows an optical response of a preset signal and a data signal

FIG. 7 shows preset signals for pixel electrode for two adjacent rows consisting of 6 pulses of opposite polarities,

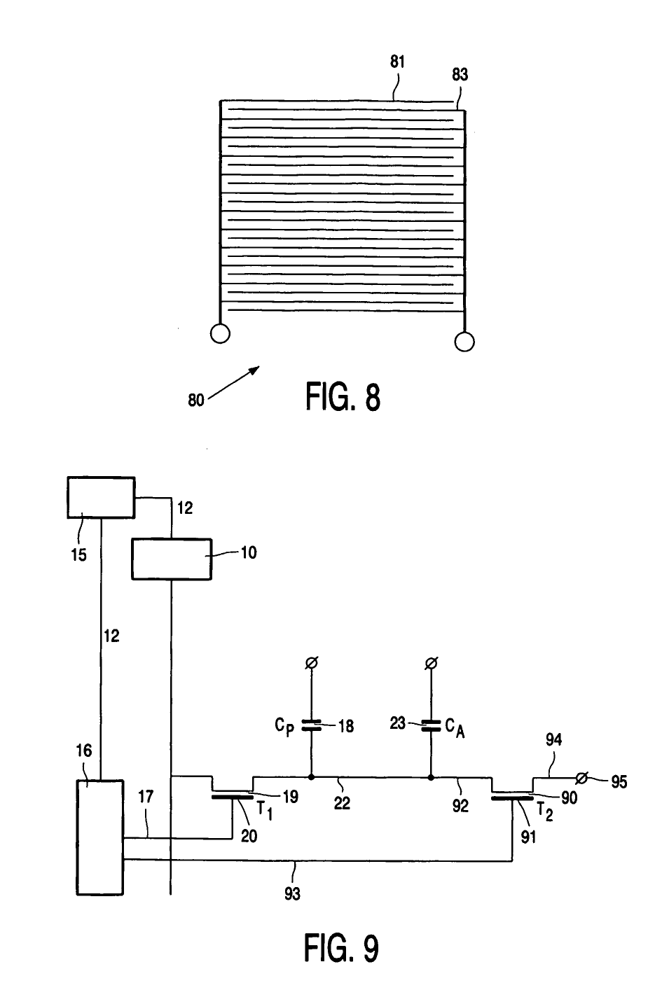

FIG. 8 shows an example of a counter electrode comprising interdigitized comb structures,

FIG. 9 shows an equivalent circuit of a display element with two TFTs,

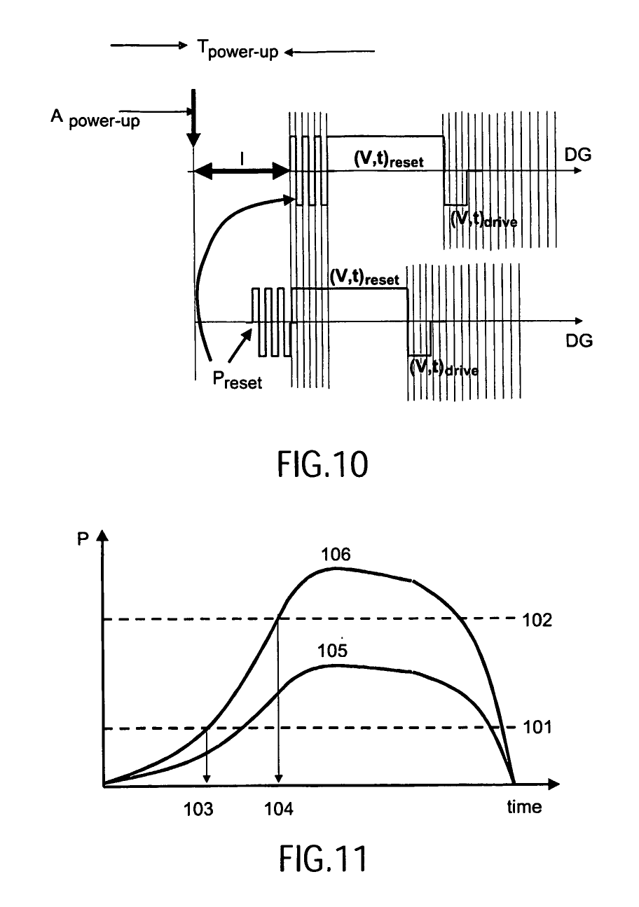

FIG. 10 illustrates a first embodiment of the invention and

FIG. 11 illustrates a second embodiment of the invention.

The Figures are schematic and not drawn to scale, and, in general, like reference numerals refer to like parts.

FIG. 1 diagrammatically shows a cross section of a portion of an electrophoretic display device 1, for example of the size of a few display elements, comprising a base substrate 2, an electrophoretic film with an electronic ink which is present between two transparent substrates 3, 4 for example polyethylene, one of the substrates 3 is provided with transparent picture electrodes 5 and the other substrate 4 with a transparent counter electrode 6. The electronic ink comprises multiple micro capsules 7, of about 10 to 50 microns. Each micro capsule 7 comprises positively charged white particles 8 and negative charged black particles 9 suspended in a fluid F. When a positive field is applied to the pixel electrode 5, the white particles 8 move to the side of the micro capsule 7 directed to the counter electrode 6 and the display element become visible to a viewer. Simultaneously, the black particles 9 move to the opposite side of the microcapsule 7 where they are hidden to the viewer. By applying a negative field to the pixel electrodes 5, the black particles 9 move to the side of the micro capsule 7 directed to the counter electrode 6 and the display element become dark to a viewer (not shown). When the electric field is removed the particles 8, 9 remains in the acquired state and the display exhibits a bi-stable character and consumes substantially no power.

FIG. 2 shows diagrammatically an equivalent circuit of a picture display device 1 comprising an electrophoretic film laminated on a base substrate 2 provided with active switching elements, a row driver 16 and a column driver 10. Preferably, a counter electrode 6 is provided on the film comprising the encapsulated electrophoretic ink, but could be alternatively provided on a base substrate in the case of operation using in-plane electric fields. The display device 1 is driven by active switching elements, in this example thin film transistors 19. It comprises a matrix of display elements at the area of crossing of row or selection electrodes 17 and column or data electrodes 11. The row driver 16 consecutively selects the row electrodes 17, while a column driver 10 provides a data signal to the column electrode 11. Preferably, a processor 15 firstly processes incoming data 13 into the data signals. Mutual synchronisation between the column driver 10 and the row driver 16 takes place via drive lines 12. Select signals from the row driver 16 select the pixel electrodes 22 via the thin film transistors 19 whose gate electrodes 20 are electrically connected to the row electrodes 17 and the source electrodes 21 are electrically connected to the column electrodes 11. A data signal present at the column electrode 11 is transferred to the pixel electrode 22 of the display element coupled to the drain electrode via the TFT. In the embodiment, the display device of FIG. 1 also comprises an additional capacitor 23 at the location at each display element 18. In this embodiment, the additional capacitor 23 is connected to one or more storage capacitor lines 24. Instead of TFT other switching elements can be applied such as diodes, MIM's, etc.

FIGS. 3 and 4 show drive signals of a conventional display device. At the instance t₀, a row electrode 17 is energized by means of a selection signal Vsel (FIG. 3.), while simultaneously data signals Vd are supplied to the column electrodes 11. After a line selection time T_{L} has elapsed, a subsequent row electrode 17 is selected at the instant t₁, etc. After some time, for example, a field time or frame time, usually 16.7 msec or 20 msec, said row electrode 17 is energized again at instant t₂ by means of a selection signal Vsel, while simultaneously the data signals Vd are presented to the column electrode 11, in case of an unchanged picture. After a selection time T_{L} has elapsed, the next row electrode is selected at the instant t₃. This process is repeated. Because the bistable character of the display device, the electrophoretic particles remains in their selected state and the repetition of data signals can be halted after several frame times when the desired grey level is obtained. Usually, the image update time is several frames.

FIG. 5 shows a first signal 51 representing an optical response of a display element of the display device of FIG. 2. on a data signal 50 comprises pulses of alternating polarity after a dwell period of several seconds. In FIG. 5 the optical response 51 is indicated by ---- and the data signal by ______. Each pulse 52 of the data signal 50 has a duration of 200 ms and a voltage of alternating plus and minus 15 V. FIG. 5 shows that the optical response 51 after the first negative pulse 52 is not a desired grey level, which is obtained only after the third or fourth negative pulse.

In order to improve the accuracy of the desired grey level with the data signal the processor 15 generates a single preset pulse or a series of preset pulses before the data pulses of a next refresh field, where the pulse time is typically 5 to 10 times less than the interval between an image update and a next subsequent image update. In case the interval between two image updates is 200 ms. The duration of a preset pulse is typically 20 ms.

FIG. 6 shows the optical response of a data signal 60 of the display device of FIG. 2 as a response of a series of 12 preset pulses of 20 ms and data pulses of 200 ms having a voltage of alternating polarity of plus and minus 15 V. In FIG. 6 the optical response 51 is indicated by ----, the improved optical response 61 by -.-.-.-.- and the data signal by ______. The series of preset pulses consists of 12 pulses of alternating polarity. The voltage of each pulse is plus or minus 15 V. FIG. 6 shows an significant increase of the grey scale accuracy, the optical response 61 is substantially at an equal level as the optical response after the fourth data pulse 55. The application of preset pulses, which are pulses having an energy sufficient to release the electrophoretic particles at a first position near one of the two electrodes corresponding to a first optical state, but too low to enable the particles to reach a second position near the other electrode corresponding to a second optical state thus increases the quality of the image. However, some flicker may become visible introduced by the preset pulses, see optical response 56. In order to reduce the visibility of this flicker, the processor 15 and the row driver 16 can be arranged such that the row electrodes 17 associated with display elements are interconnected in two groups, and the processor 15 and the column driver 10 are arranged for executing an inversion scheme by generating a first preset signal having a first phase to the first group of display elements and a second reset signal having a second phase to the second group of display element, whereby the second phase is opposite to the first phase. Alternatively, multiple groups can be defined, whereto preset pulses are supplied with different phases. For example, the row electrodes 17 can be interconnected in two groups one of the even rows and one group of the odd row whereby the processor generates a first preset signal consisting of six preset pulses of alternating polarity of plus and minus 15 V starting with a negative pulse to the display elements of the even rows and a second preset signal consists of six preset pulses of alternating polarity of plus and minus 15 V starting with a positive pulse to display elements of the odd rows.

FIG. 7 shows two graphs indicative for an inversion scheme. A first graph 71 relates to a first preset signal consisting of 6 preset pulses of 20 ms supplied to a display element of an even row n and a second graph 72 related to a second preset signal consisting of 6 preset pulses of 20 ms supplied to a display element of an odd row n+1, whereby the phase of the second preset signal is opposite the phase of the first preset signal. The voltage of the pulse is alternating between plus and minus 15 V.

Instead of the series of preset pulses applied to two or more different groups of rows, the display elements can be divided in two groups of columns, for example, one group of even columns and one group of odd columns whereby the processor 15 executes an inversion scheme by generating a first preset signal consisting of six preset pulses of alternating polarity of plus and minus 15 V starting with a negative pulse to the display elements of the even columns and a second preset signal consists of six preset pulses of alternating polarity of plus and minus 15 V starting with a positive pulse to the display elements of the odd columns. Here, all rows can be selected simultaneously. In further embodiments, inversion schemes as just discussed can be simultaneously supplied to both rows and columns to generate a so called dot-inversion scheme, which still further reduces optical flicker.

In a further embodiment the counter electrode 80 is shaped as two interdigitized comb structures 81, 83 as shown in FIG. 8 in order to reduce optical flicker. This kind of electrode is well known to the skilled person. The two counter electrodes 81, 83 are coupled to two outputs 85, 87 of the processor 15. Furthermore, the processor 15 is arranged for generating an inversion scheme by supplying a first preset signal consisting of six preset pulses of 20 ms and alternating polarity of plus and minus 15 V starting with a negative pulse to the first comb structure 81 and a second preset signal consisting of six preset pulses of 20 ms of alternating polarity of plus and minus 15 V starting with a positive pulse to the to the second comb structure 83, whilst holding the pixel electrode 23 at 0 V. After the preset pulses are supplied the two comb structures 81, 83 can be connected to each other before new data is supplied to display device.

In a further embodiment, the preset pulses can be applied by the processor 15 via the additional storage capacitors 23 by charge sharing between the additional storage capacitor 23 and the pixel capacitance 18. In this embodiment, the storage capacitors on a row of display element are connected to each other via a storage capacitor line and the row driver 16 is arranged to interconnect these storage capacitor lines to each other in two groups enabling inversion of the preset pulses over two groups, a first group related to ever rows of display elements and a second group related to odd rows of picture elements. In order to improve grey scale reproduction before new data is supplied to the display element, the row driver executes an inversion scheme by generating a first preset signal consisting of 6 preset pulses of alternating polarity to the first group and a second preset signal consisting of 6 preset pulses of alternating polarity to the second group whereby the phase of the second signal is opposite the phase of the first signal. After the preset pulses are supplied to the display elements, the storage capacitors can be grounded before the new data is supplied to the display elements.

In a next further embodiment, the preset pulses can be applied directly to the pixel electrode 22 by the processor 15 via an additional thin film transistor 90 coupled via its source 94 to a dedicated preset pulse line 95 as shown in FIG. 9. The drain 92 is coupled to the pixel electrode 22. The gate 91 via a separate preset pulse addressing line 93 to the row driver 16. The addressing TFT 19 must be non-conducting by, for example, setting the row electrode 17 to 0 V.

When the preset signal is applied to all display elements simultaneously flicker may occur. Therefore, preset signal inversion is applied by division of the additional thin film transistors 90 in two groups, one group connected with display elements of even rows and one group connected with display elements of odd rows. Both groups of TFT's 90 are separately addressable and connected to the preset pulse lines 95. The processor 15 executes an inversion scheme by generating a first preset signal consisting of, for example, 6 preset pulses of 20 ms and a voltage 15 V with alternating polarity to the first group of TFT's 90 via the preset pulse line 95 and a second preset signal consisting of 6 preset pulses of 20 ms and a voltage of 20 ms and alternating polarity to the second groups of TFT's 90 whereby the phase of the second signal is opposite the phase of the first signal. Alternatively, a single set of TFT's addressable in the same time can be attached to two separate preset pulse lines with inverted pre set pulses.

After the preset signal are supplied to the TFT's 90, the TFT's are deactivated before new data is supplied via the column drivers 10.

Furthermore, further power reductions are possible in the described embodiments by applying any of the well-known charge recycling techniques to the (inverted) preset pulse sequences to reduce the power used to charge and discharge pixel electrodes during the preset pulse cycles.

The above illustrates a first aspect of the invention, the application of preset (or shaking pulses).

Further figures illustrates the second aspect of the invention, namely the timing of the application of the preset or shaking pulses vis-à-vis power-up. Shaking increases the accuracy of grey scales, removes image retention, accounts for dwell time and, if carried out correctly, is optically invisible to the user, as explained above. Whilst this is advantageous when the display is already in an active (powered) mode, one of the main advantages of type of display as described in the opening paragraph is their low power consumption resulting from the fact that the image remains present after the power has been switched off (due to the bi-stability). For this reason, display device will spend the majority of its life turned off (“standby mode”). If the system needs to be fully powered up before we can start the image update with the shaking pulses, this will slow down the image update. Since a power-up is frequent a decrease of the total time between power-up and the time at which the image becomes visible is preferred.

The second aspect of the invention is aimed to decrease the image update time in an electrophoretic display which is in a “standby” mode by incorporating a shaking sequence into the power-up (or initiate or wake-up) mode of the system, i.e. by applying the preset signal or preset pulses upon receipt of a power-up or image change operation, prior to completion of receipt of image update data.

Whilst several embodiments of the invention will be described below, all rely upon the fact that application of preset pulses (shaking), whilst very beneficial for a high quality image update, can be data independent (shaking does not have to depend upon the details of the image to be displayed), can be made optically invisible to the user and, as the optical state before and after shaking is substantially unchanged, can be implemented at any time (also the WRONG time) without deteriorating the performance of the display.

For this reason, in some of the embodiments shaking pulses may be applied to the display even if there is no certainty that an image update will follow the shaking. If, as will usually happen, an image update does follow a power-up (or mode change) image update time is decreased (as the shaking has already been carried out). If, in the less likely case that no image update follows a power-up (or mode change), no harm has been done to the image on the display.

In the first embodiment, it is proposed to incorporate a shaking pulse sequence into every power-up or mode change cycle. The operation of the display in it application (e-book, PDA etc.) will be as follows (FIG. 10):
A signal to power-up or change operation mode is received by the application (i.e. a button/keyboard is pressed, power switch turned on, e-book/PDA opened up etc.)
The power supply of the application starts up
The display controller and driver IC's are (partially) initiated.
As soon as the display controller and driver IC's are sufficiently initiated, data independent shaking pulses are sent to the display.
If, after application of the shaking pulses, display controller are fully initiated an image update is required, the image update waveforms (without the first shaking pulses) are sent to the display

FIG. 10 illustrates the situation without the second aspect of the invention (top half of the figure) and with the second aspect of the invention (bottom half of the figure). After application of the power-up (A_{power-up}), an initiation period commences (T_{power-up} or I), during this initiation period the image update data, such as the length of the reset pulse (V,t)ᵣₑₛₑₜ and length of the drive pulse (V,t)_{drive} is gathered, wherafter the shaking pulse is applied without application of the second aspect (top half of the figure), whereas in devices and methods in accordance with the invention the preset pulses are applied, independent of if there is even any image data during the power-up period. As a consequence the start-up-period, i.e. the period between A_{power-up} and the end of the drive pulse (V,t)_{drive} is shortened. In a power-up situation, the shaking pulses are therefore applied during a time period where the entire system is not fully operational i.e. during the initialisation/start-up period.

In many situations, the request for an image update will be originated by a touch input (i.e pressing a hardware or software button). Touch input events usually require a period of several 100 msec, as the touch pressure has to be built up to exceed a predefined value for a certain period of time (to make sure that the button has really been touched!). In a preferred embodiment the onset of the preset pulses is triggered at a touch time shorter than the touch time for initiating an update of the image data, at which point we propose to start up an initialisation with shaking sequence. This reduced touch event will be detected more quickly. The onset of the application of the preset pulse(s) is thus done in anticipation of a power-up or image change operation (i.e. a full touch event).

This is schematically illustrated in FIG. 11.

As a function of time (horizontal axis) the pressure applied to a button (vertical axis) is shown. At a certain pressure level 101 the preset pulses are applied, thus at a time 103, at application of a larger touch pressure 102 the power-up or image change operation (i.e. e.g. gathering of image update data) is started, which in FIG. 10 corresponds to point A_{power-up}. If a full touch event is detected, the sequence will begin more quickly, whereby the image update will again be shorter. In the case of a false touch event (reduced touch detected, full touch not detected), no adverse effects will be seen in the display, as the shaking leaves the display in the same state as before shaking occurs.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention.

The present invention has been described in terms of specific embodiments, which are illustrative of the invention and not to be construed as limiting. The invention may be implemented in hardware, firmware or software, or in a combination of them. Other embodiments are within the scope of the following claims.

It will be obvious that many variations are possible within the scope of the invention without departing from the scope of the appended claims.

1. A display device comprising electrophoretic particles, a display element comprising a pixel electrode and a counter electrode between which a portion of the electrophoretic particles are present, and control means for supplying a drive signal to the electrodes to bring the display element in a predetermined optical state corresponding to the image information to be displayed, characterized in that control means are further arranged for supplying a preset signal preceding the drive signal comprising a preset pulse having an energy sufficient to release the electrophoretic particles at a first position near one of the two electrodes corresponding to a first optical state, but too low to enable the particles to reach a second position near the other electrode corresponding to a second optical state, and in that the control means are further arranged for supplying the preset signal, in anticipation of or upon receipt of a power-up or image change operation.

2. A display device as claimed in claim 1, for devices having a touch button, wherein the control means are arranged to initiate preset pulses starting at a touch time shorter than the touch time for initiating an update of the image data.

3. A display device as claimed in claim 1 wherein the control means are further arranged for generating an even number of preset pulses.

4. A display device as claimed in claim 1 wherein one of the electrodes comprises a data electrode and the other electrode comprises a selection electrode and the control means further comprising first drive means for applying a selection signal to the selection electrodes and second drive means for applying a data signal to the data electrode.

5. A display device as claimed in claim 1 wherein the display device is provided with an active matrix addressing to provide the data signals to the pixel electrodes of the display elements.
